(19) United States
(12) Patent Application Publication
(10) Pub. No.: US 2024/0279983 A1
(43) Pub. Date: Aug. 22, 2024

(54) PRIVACY PROTECTION DEVICE

(71) Applicant: Sabine Mengel, Obergriesbach (DE)

(72) Inventor: Sabine Mengel, Obergriesbach (DE)

(21) Appl. No.: 18/571,289

(22) PCT Filed: Jun. 17, 2022
(86) PCT No.: PCT/DE2022/000065

§ 371 Date: Dec. 18, 2023

(30) Foreign Application Priority Data
Jun. 18, 2021 (DE) 10 2021 003 124.5

(51) Int. Cl. E06B 9/24

(52) U.S. Cl. CPC E06B 9/24; G02B 6/0016; E06B 2009/2464; E06B 2009/247

(57) ABSTRACT

Disclosed herein is a privacy protection device that separates a first area and an opposite second area and is arranged to protect the second area from a view from the first area and to allow a view from the second area into the first area. The privacy protection device includes a brightness difference device having a first side facing the first area and a second side opposite to the first side facing the second area, wherein the first side of the brightness difference device is at least temporarily brighter than the second side of the brightness difference device, in that the first side, in contrast to the second side, is self-illuminating in the direction of the first area, and/or the first side has a higher reflectivity than the second side and the first side is illuminated by a lighting device integrated in the privacy protection device.

### CROSS-REFERENCE TO RELATED APPLICATIONS

The present application is a U.S. National Stage Application of International Application PCT/DE2022/000065, filed Jun. 17, 2022, and claims the priority of the German patent application DE 10 2021 003 124.5 of Jun. 18, 2021, the entire disclosures of the above-listed applications of which is are hereby explicitly incorporated by reference.

### FIELD

The present disclosure relates to a privacy protection device. In particular, the present disclosure relates to a privacy protection device that makes it more difficult to recognize structures in a protected interior space from an exterior space, but which only insignificantly impairs the view from the interior space into the exterior space.

### STATE OF THE ART

Privacy protection devices, which for example protect rooms from being viewed through openings (e.g. windows), usually have one of two properties.

Either they obstruct the view through the opening equally in both directions, as is the case with blinds, for example. Areas of the viewing aperture are covered by opaque (or at least diffusing or distorting) parts of the blinds. If necessary, other areas may be left uncovered by the blinds and allow an unobstructed view. In this case, privacy is almost only guaranteed to the extent that the view from the interior is restricted.

Alternatively, the privacy protection device is designed in such a way that the areas provided with a material for the privacy protection device are also partially permeable to light, such as semi-translucent mirrors. In this case, the privacy protection device function is largely dependent on the interior being dark or at least darker than the exterior.

However, there is a need for a privacy protection device that makes it difficult to see from an exterior space into an interior space (or to recognize structures in the interior space from the exterior space), but does not significantly impair the view from the interior space into the exterior space, and the visual protection effect can still be present even if it is just as bright in the interior space as in the exterior space or even brighter.

### BRIEF DESCRIPTION

A privacy protection device according to claim 1 is provided. Further embodiments are given in the sub-claims.

Hereinafter, to simplify the description, an area to be protected from view may be referred to as an interior area or interior space, a side of the privacy protection device facing this area may be referred to as an interior side, and correspondingly an area that is separated from the interior area by the privacy protection device and from which a view could be attempted may be referred to as an exterior area or exterior space, the corresponding side of the privacy protection device as an exterior side, without the corresponding areas actually having to be inside or outside of anything, respectively. However, of course, in various embodiments, the privacy-protected interior area may actually be inside an interior, such as a building, and the interior may be protected from view from the outside, such as from outside the building.

According to various embodiments, a first side of a privacy protection device may be designed (e.g., self-luminous or illuminated) to appear brighter to an observer located in a first area facing the first side of the privacy protection device, e.g., a first space, e.g., an outdoor space, than the structures in a second area located behind the privacy protection device as viewed by the observer, e.g., a second space, e.g., an indoor space, to which a second side of the privacy protection device faces.

In various embodiments, a privacy protection device is provided that separates a first area and an opposite second area and is arranged to at least temporarily protect the second area from a view from the first area and to provide a view from the second area into the first area. The privacy protection device may include a brightness difference device having a first side facing the first area (e.g. the exterior) and a second side opposite to the first side and facing the second area (e.g. the interior), wherein the first side of the brightness difference device may be at least temporarily brighter than the second side of the brightness difference device.

Brightness difference device, in that the first side, in contrast to the second side, is self-luminous in the direction of the first area, and/or the first side has a higher reflectivity than the second side and the first side is illuminated (and thus brightened or lightened) by a lighting device integrated in the privacy protection device.

According to various embodiments, the privacy protection device may have a plurality of transparent openings that allow the user to look from the second, privacy-protected area into the first area.

In various embodiments, the bright part may be designed to be reflective, e.g. diffusely reflective. The dark part can, for example, be designed to be absorbent, e.g. equipped with a dark color.

In various embodiments in which the brightness difference device is (self-) illuminating on the outside (of the first side), the brightness difference device may be formed such that it emits light towards the first area (e.g. towards the outside space), but emits substantially no light towards the second area (e.g. towards the inside space)

In order to allow only an insignificantly impaired view from the second area into the first area (e.g. from the interior into the exterior), for example even if the second area is more brightly lit than the exterior, the brightness difference device may be designed to be less reflective on the inside, for example absorbent, e.g. highly absorbent. For example, the brightness difference device may be black or dark on the inside (e.g. dark gray, anthracite, dark blue or brown) and white or bright on the outside (e.g. light gray, light yellow, beige, neon, fluorescent and/or phosphorescent).

In various embodiments, the privacy protection device may further include an lighting device.

In various embodiments, the lighting device may have an electroluminescent device, an organic light-emitting diode (OLED) or a lighting device that may be arranged as a structured surface in a manner comparable to an OLED, which may be arranged on the first side, for example as a structured surface, so that the lighting device directly emits a light emitted by the lighting device into the first area. The lighting device may be designed and arranged in such a way that no light or essentially no light is emitted from it into the second area. The lighting device can, for example, form the bright part of the brightness difference device or a part thereof.

In various embodiments, the lighting device may, for example, include at least one point light source (to be understood as a light source in which light is essentially emitted from a narrow spatial area in several directions, as opposed to an area light source). The light source may, for example, include an inorganic light-emitting diode (LED), an incandescent lamp, an energy-saving lamp, a halogen lamp or the like.

In various embodiments, the lighting device may be designed such that its light is emitted from the bright part of the brightness difference device into the first area, for example is reflected or scattered into the first area.

In various embodiments, the lighting device may be arranged such that its light impinges on the first side of the privacy protection device, in particular on at least a part of the bright part of the brightness difference device. In this case, the privacy protection device may be designed, for example with regard to the relative arrangement of the brightness difference device and the lighting device, in such a way that essentially no light from the lighting device is transmitted through the brightness difference device into the interior. The light from the lighting device may be scattered and/or reflected by the first side, e.g. the outside (e.g. by the bright part of the brightness difference device) of the privacy protection device.

In various embodiments, the lighting device may be formed in such a way that its light is guided in a transparent substrate of the privacy protection device and part of the guided light is emitted towards the first area from a scattering surface of the transparent substrate pointing towards the first area. The light may be guided in the transparent substrate in light guiding regions. In the light guiding regions, a refractive index of the transparent substrate may be higher than in adjacent regions of the transparent substrate.

In various embodiments, an opaque device may be arranged on the second side, which may, for example, prevent light emitted by the lighting device in the direction of the second area from actually being emitted there.

In various embodiments, for example in a case in which light is emitted from light guide areas in the direction of the first area, the opaque device may be designed to be reflective in the direction of the light guide areas. In the direction of the second area, the opaque device may be dark, e.g. black, brown, blue or gray.

If the light guided in the light guide areas is UV light and therefore invisible to humans, the light guide areas may have the entire transparent substrate. A fluorescent or phosphorescent layer may be arranged between the opaque device and the transparent substrate. The UV radiation directed towards the fluorescent or phosphorescent layer can excite the fluorescent or phosphorescent layer to emit in the visible wavelength range, which is emitted towards the first area. If part of the UV radiation guided in the transparent substrate is emitted in the direction of the second area, this is not visible to a user in the second area.

In various embodiments, for example in a case in which the privacy protection device has a lighting device, the privacy protection device may further include an energy source, for example a power source. The power source may include, for example, a battery, a rechargeable battery, a power supply, or any other power source.

In various embodiments, the energy source may include at least one solar cell. Furthermore, the energy source may include devices, for example an energy storage device, which may be used to store energy generated by the solar cell and/or to make it usable for the privacy protection device, for example the lighting device of the privacy protection device.

In various embodiments, the privacy protection device may further include a frame. The brightness difference device may be arranged in an opening formed in or by the frame. The frame may serve to stabilize the privacy protection device. Furthermore, the lighting device for illuminating the bright side of the screen may be arranged in the frame. The light from the lighting device may leave the frame through openings formed in the frame. Furthermore, the energy source may be accommodated in the frame. Furthermore, the at least one solar cell may be arranged on the frame.

In various embodiments, a wavelength of light emitted and/or reflected and/or scattered by the first side of the privacy protection device may have a broad wavelength distribution. This can make it more difficult to filter out (e.g. block) the light emitted or reflected and/or scattered by the privacy protection device by means of a filter. In various embodiments, a wavelength of light that is emitted or reflected and/or scattered by the first side of the privacy protection device may be adapted to a wavelength used for illumination in the second area. As a result, even when using a filter to filter out (e.g. block) the light from the privacy protection device, light originating from the second area may also be filtered out (e.g. blocked).

In various embodiments, a wavelength of light emitted and/or reflected and/or scattered from the first side of the privacy protection device may be varied in time, for example by means of a plurality of light emitting devices of different wavelengths, and/or by means of filter(s) disposed between the light emitting device and points at which the light leaves the privacy protection device. This may make it more difficult to filter out (e.g. block) the light emitted or reflected and/or scattered by the privacy protection device by means of a filter.

In various embodiments, a wavelength of light emitted and/or reflected and/or scattered by the first side of the privacy protection device may have only one or a limited number of wavelengths. This may make it possible to filter out (e.g. block) the light emitted or reflected and/or scattered by the privacy protection device by means of a filter.

In various embodiments, the light from the privacy protection device may be configured, for example with respect to a wavelength and/or an arrangement, such that the light emitted (e.g., directly emitted and/or reflected and/or scattered) from the first side results in a pattern, for example a colored pattern.

In various embodiments, the privacy protection device may further include at least one brightness sensor.

In various embodiments, the at least one brightness sensor may be used to generate a privacy protection effect of the privacy protection device when the brightness measured by the at least one brightness sensor fulfills a predetermined condition, for example, falling below a brightness threshold in the first area, exceeding a brightness threshold in the second area, and/or exceeding a brightness difference or a brightness ratio between the second area and the first area.

### BRIEF DESCRIPTION OF THE DRAWINGS

In the drawings, the same reference signs generally denote the same parts in the views. The drawings are usually not to scale, but are intended to illustrate the principle of the disclosure. In the following description, various embodiments are described with reference to the following drawings, wherein

FIG. 1 shows an illustration of a privacy protection device according to various embodiments;

FIG. 2 shows an illustration of a privacy protection device according to various embodiments;

FIG. 3 shows illustrations of two privacy protection devices according to various embodiments;

FIG. 4 shows an illustration of a privacy protection device according to various embodiments;

FIG. 5 shows an illustration of a privacy protection device according to various embodiments;

FIG. 6 shows an illustration of a privacy protection device according to various embodiments;

FIG. 7 shows an illustration of a privacy protection device according to various embodiments.

FIG. 8 shows an illustration of a privacy protection device according to various embodiments, and

FIG. 9 shows an illustration of a privacy protection device according to various embodiments.

### DETAILED DESCRIPTION

In the figures, the privacy protection devices according to various embodiments are marked with the reference sign 100. To explain individual embodiments, these are additionally differentiated by means of trailing lower-case letters. In the following, it is sometimes omitted to use both reference signs.

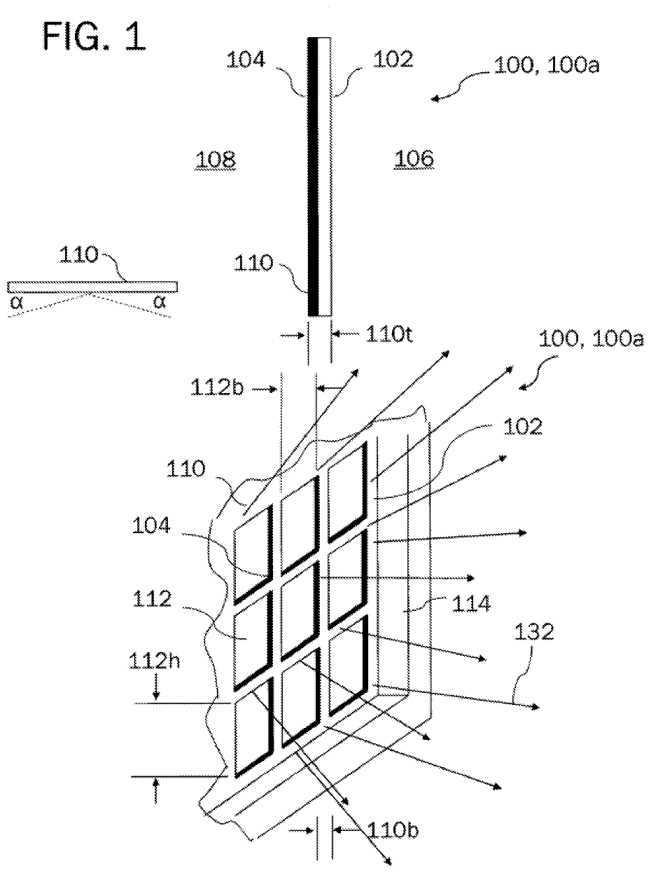

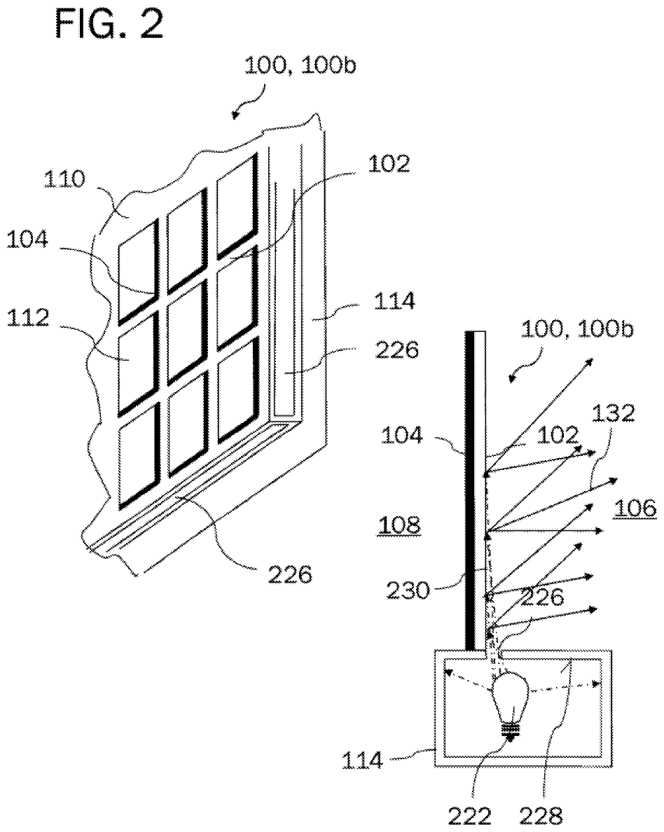

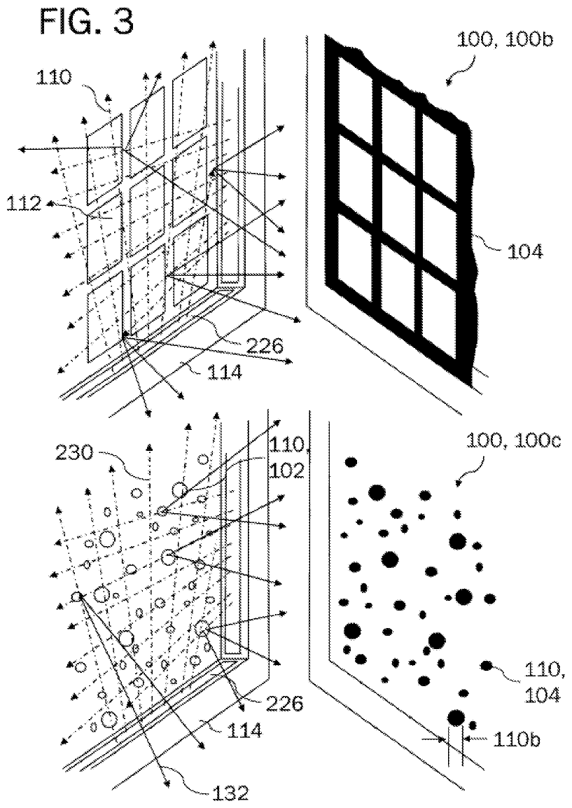

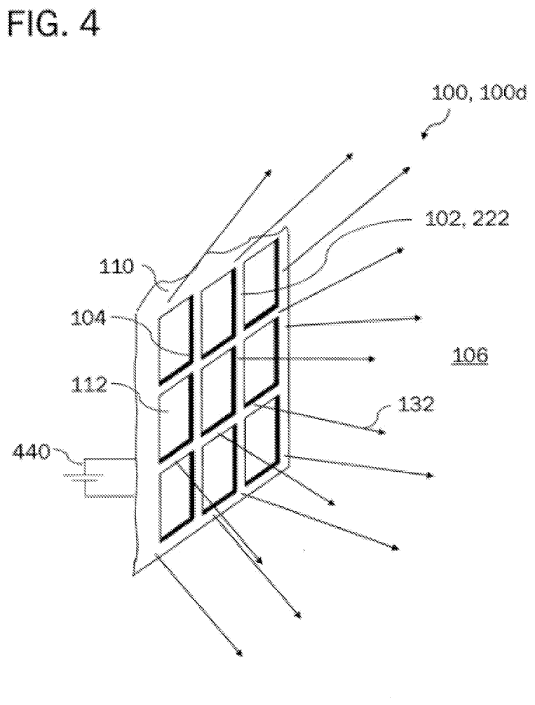

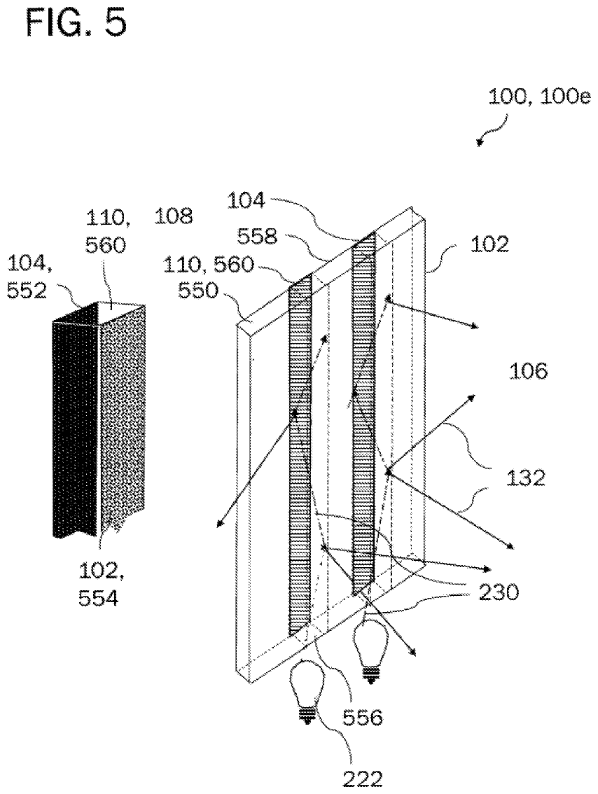

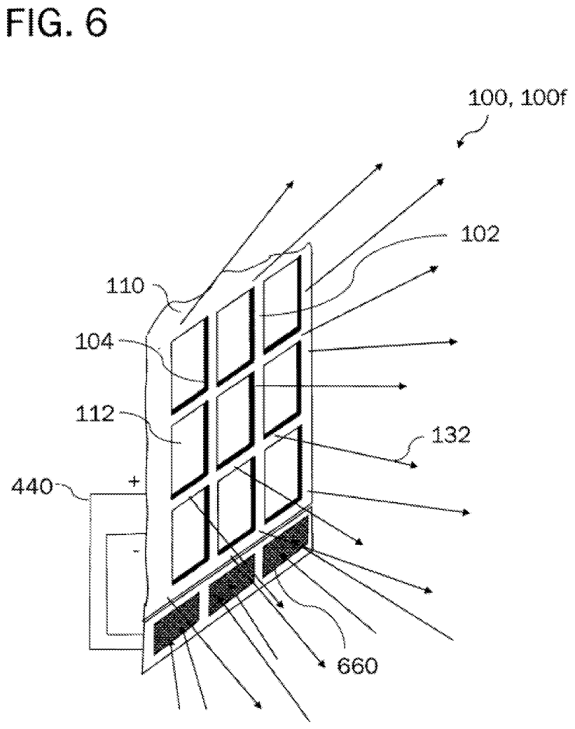

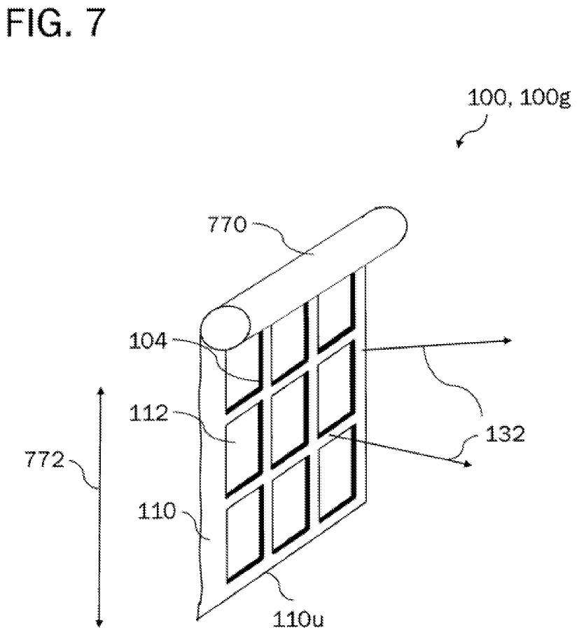

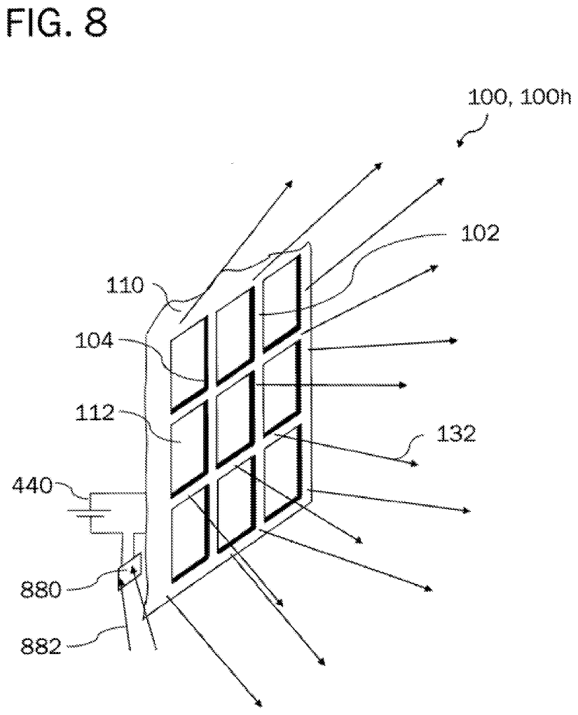

FIG. 1 shows a detailed cross-sectional view and a perspective view of a privacy protection device 100, 100a according to various embodiments. FIG. 2 shows a detailed cross-sectional view and a perspective view of a privacy protection device 100, 100b according to various embodiments. FIG. 3 shows, at the top, two perspective views from two different viewing directions of the privacy protection device 100, 100b of FIG. 2. At the bottom, FIG. 3 shows two perspective views from two different viewing directions of a privacy protection device 100, 100c according to various embodiments. FIG. 4 shows a perspective view of a privacy protection device 100, 100d according to various embodiments. FIG. 5 shows a perspective view and a partial magnification of a privacy protection device 100, 100e according to various embodiments. FIG. 6 shows a perspective view of a privacy protection device 100, 100f according to various embodiments. FIG. 7 shows a perspective view of a privacy protection device 100, 100g according to various embodiments, and FIG. 8 shows a perspective view of a privacy protection device 100, 100h according to various embodiments.

The privacy protection device 100 may separate a first area 106 and a second area 108. The privacy protection device 100 may be arranged to at least temporarily protect the second area 108 from a view from the first area 106 and to provide a view from the second area 108 into the first area 106, wherein the view from the second area 108 into the first area 106 may be provided permanently.

In various embodiments, the privacy protection device 100 may include a brightness difference device 110. The brightness difference device 110 may have a first side 102 facing the first area 106 and an opposite second side 104 facing the second area 108, wherein the first side 102 of the brightness difference device 110 may be at least temporarily brighter than the second side 104 of the brightness difference device 110, in that the first side 102, in contrast to the second side 104, is self-luminous in the direction of the first area 106, and/or the first side 106 has a higher reflectivity than the second side 104 and the first side 104 is illuminated (and thus brightened or lightened) by an lighting device integrated in the privacy protection device 100.

The brightness difference device 110 may be designed as a structured two-dimensional structure.

In various embodiments, the privacy shield device 100a may include a plurality of substantially transparent openings 112 connecting the first area 106 to the second area 108. The transparent openings 112 may, for example, be distributed across the surface of the brightness difference device 110 and may, for example, be formed as recesses or may, for example, include a transparent substrate.

In various embodiments, the privacy protection device 100 may be configured such that it is possible for an observer to perceive objects located behind the privacy protection device 100 in the first area 106 from the second area 108 through the plurality of transparent openings 112, and that it is difficult or impossible for an observer to perceive objects located behind the privacy protection device 100 in the second area 108 from the first area 106, because the light 132 reflected and/or emitted by the brightness difference device 110 dominates a light emitted from the object located in the second area 108 into the first area 106.

In other words, a viewer positioned in the first area 106 may receive light (through the transparent openings 112) from an object positioned behind the privacy protection device 100 as well as light 132 from the first side 102 of the brightness difference device 110. The first side 102 of the brightness difference device 110 may be designed to be so bright, for example by means of a phosphorescent color, self-illuminating by means of an energy source and/or scattering and/or reflecting light supplied by means of a light source, that the light reaching the viewer from the first side 102 is brighter or dominant compared to the light reaching the viewer from the object arranged behind the privacy protection device 100, so that the object arranged behind the privacy protection device 100 is not or hardly perceived, i.e. a privacy effect is achieved.

In various embodiments, an intensity of the light emitted, scattered or reflected from the first side 102 of the brightness difference device 110 may be such that a privacy effect is achieved even when the object is illuminated in the second area 108 and/or it is dark in the first area 106.

In various embodiments, the privacy protection function can essentially be limited to an effect with approximately the same brightness in the first 106 and second area 108, slightly brighter second area 108 or brighter first area 106, for example as an additional function to another function, e.g. an additional privacy protection effect of an insect screen.

In various embodiments, the bright first side 102 of the brightness difference device 110 may, for example, be provided with a phosphorescent color, for example coated therewith. In this way, a visual protection effect of the privacy protection device 100a can still be present, at least temporarily, even without an energy source, when it is somewhat darker in the first area 106 than in the second area 108, for example after dusk, when the phosphorescent dyes that have been transferred into an excited state by daylight emit light for a certain period of time.

In various embodiments, the brightness difference device 110 of the privacy protection device 100 may be configured such that light from an object disposed behind the privacy protection device 100 reaches a viewer disposed in the second area 108 through the transparent openings 112, but little or no light from the second side 104 of the brightness difference device 110. As a result, the viewer can see an object disposed in the first area 106 through the privacy protection device 100, i.e., through the transparent openings 112 of the privacy protection device 100. For the purpose, the second side 104 of the brightness difference device 110 may be designed to absorb light, e.g. dark, e.g. with a dark color. Thereby, in various embodiments, viewing an object in the first area 106 from the second area 108 may be possible even if it is brighter in the second area 108 than in the first area 108.

In various embodiments, the privacy protection device 100 may be configured such that when a viewer looks from the second area 108 into the first area 106 (and focuses on an object in the first area), the privacy protection device 100 is not perceived as an obstruction to vision, or is not substantially perceived as an obstruction to vision. To this end, dimensions of the brightness difference device 110, such as a width 110b and a thickness 110d of structures of the brightness difference device 110 and a width 112b and a height 112h of the transparent openings 112 may be matched such that the above-described effect of non-perceptibility or barely-perceptibility occurs. For example, in the brightness difference device 110, the structures, e.g. ridges as in FIG. 1, but also, for example, round structures as in FIG. 3 (bottom), or generally all structures forming the brightness difference device 110, have a width 110b, e.g. a maximum width, that is small enough and matched to the width 112b and height 112h of the transparent openings 112 such that for any point in the second area whose line of sight to one eye of the viewer may be blocked by a portion (e.g., a structure, e.g., a web having the width 110b) of the brightness difference device 110, there is a clear line of sight through one of the transparent openings 112 to the other eye of the viewer. This may allow the viewer's brain (or alternatively, for example, an image recording device) to produce an unobstructed image of the object being viewed. Such an effect is known, for example, from (black) insect screens, in which the bars are so narrow and the openings so large in comparison that they are practically invisible when looking through them to the outside.

In various embodiments, to achieve the effect described above, the width 112b and the height 112h of the openings 112 may be large enough, the openings 112 may be numerous enough, and the structures of the brightness difference device 110 may be narrow enough (at least in one direction, for example, as shown in FIG. 1: for example, the brightness difference device 110 may have strips or grids that extend in some regions across, for example, an entire width of the brightness difference device).

For example, the apertures 112 may have a width 112b and/or a height 112h in a range from about 1 mm to about 20 cm, for example in a range from about 2 mm to about 5 cm, for example in a range from about 1 cm to about 3 cm. For example, the structures of the brightness difference device 110 may have a width 112b in a range from about 0.1 mm to about 3 cm, for example from about 0.5 mm to about 2 cm, for example from about 1 mm to about 1 cm. In various embodiments, the width 112b of the structures of the brightness difference device 110 may have a maximum of ⅓ of the value of the width 112b and/or height 112h of the openings 112 (e.g., smaller of the values), for example a maximum of ⅕, for example a maximum of 1/10, for example a maximum of 1/20.

In various embodiments, for example in a case where a thickness 110d of the brightness difference device 110 is not negligible, the thickness 110t may be included in a dimensioning of the width 112b and the openings 112 (e.g. width 112b and height 112h), so that the effect described above (of the privacy protection device 100a at most insignificantly impairing the view) applies at least to a viewer looking through the privacy protection device outside an angle α (between the line of sight and the plane of the privacy protection device, see FIG. 1), wherein a may be less than about 60°, for example less than about 45°, for example less than about 30°, for example less than about 10°. In various embodiments, the brightness difference device 110 may be or may be formed of any suitable material using methods known in principle to those skilled in the art, such as a fabric, e.g., a natural material, e.g., cotton or flax, or an artificial material, e.g., a polymer, or, for example, paint, a textured substrate, a combination thereof, or any other material or combination of materials capable of realizing the properties described above. For example, a dark, e.g., black, fabric may be printed or otherwise coated, e.g., sprayed, on the first side 102 with a light color, e.g., a white color or a phosphorescent color, without the second side 104 also being printed or coated. According to a further example, a transparent support, for example a transparent film or a transparent plate, for example an (acrylic) glass plate, can first be printed in a structured manner with a light paint, which forms the light first side 102 of the brightness difference device 110, and then, covering the structured light paint in a structured manner, be printed with a dark paint, so that the dark second side 104 is formed on the paint layer forming the first side 102. This process can of course also be carried out in reverse, and/or additional (paint) layers may be arranged, for example a separating layer between the two paint layers, and/or a protective layer over both paint layers. In a further embodiment example, light and dark plastic may be formed, e.g. pressed, simultaneously or successively in a mold to form a lightness difference device 110 having the light first side 102 made of the light plastic and the dark second side 104 made of the dark plastic.

In various embodiments, the brightness difference device 110 may be substantially self-supporting, such as a rigid fabric or rigid textured surface, in various embodiments, the brightness difference device 110 may be disposed on and/or in a support and/or stabilized by a frame. In various embodiments, the privacy protection device 110a may further include a frame 114. The frame 114 may be used for stabilization, for example. For example, the brightness difference device 110 may be attached, such as fixed, to the frame 114. In various embodiments, the frame 114 may surround the brightness difference device 114 from all sides (with respect to the surface of the brightness difference device 110). In other embodiments, the frame 114 may be formed such that it only partially surrounds the brightness difference device 110.

In various embodiments, the privacy protection device 100 may be substantially rectangular, as indicated in the figures. In other embodiments, the privacy protection device 100 (and also the brightness difference device 110) may be any other convenient shape, such as triangular or generally polygonal, elliptical, round, or irregularly shaped or multi-piece.

The privacy protection device 100, 100b, an example of which is shown in FIG. 2, may essentially correspond to the privacy protection device 100a, for example with regard to materials, dimensioning, function, etc., so that a repetition of the description in this regard is omitted.

In various embodiments, the privacy protection device 100b may further include a lighting device 222. The lighting device 222 may be any lighting device 222 suitable for illuminating the brightness difference device 110, e.g., the first side 102 of the brightness difference device 110, with light 230 such that light 132, also referred to as disturbing light 132, is emitted from the brightness difference device 110, i.e., the first side 102, that disturbs looking from the first area into the second area. The light 230 may, for example, be reflected and/or scattered and/or absorbed by the first side 102 and re-emitted (e.g., at a longer wavelength) and form the disturbing light 132 after reflection and/or scattering and/or re-emission. For example, the light emitting device 222 may include at least one light emitting diode, e.g., at least one inorganic or organic light emitting diode, at least one incandescent light bulb, at least one halogen light, or the like, or a combination thereof.

In various embodiments, the lighting device 222 may be arranged such that the light 230 strikes the brightness difference device 110 such that the disturbing light 132 is emitted (e.g., reflected and/or scattered and/or re-emitted) only into the first area 106 and not, or at most insignificantly, into the second area.

For example, in various embodiments, the lighting device 222 may be disposed on at least one edge of the brightness difference device 110, such as in the frame 114.

In various embodiments, the light emitting device 222 may be provided with a diaphragm (here, light apertures 226 in the frame 114) that causes the light 230 from the light emitting device 222 to impinge on the brightness difference device 110, e.g., on the first side 102 of the brightness difference device 110, e.g. by means of limiting the position and angle at which the light 230 strikes the brightness difference device 110, for example such that only the first side 102 is struck at a shallow angle, such that substantially neither a portion of the light 230 that is directly emitted from the light emitting device 222 nor a portion of the scattered and/or reflected and/or re-emitted light 132 is emitted into the second area 108. In various embodiments, the aperture may be configured differently. For example, the lighting device 222 itself may be formed such that it emits the light 230 only in a narrow angular range. In various embodiments, an optical device, e.g., lenses, mirrors, or a combination thereof, may be used instead of the aperture or in addition to the aperture to direct, e.g., focus and position the light 230 such that the effect described above (no penetration of the light 230 and the disturbing light 132 into the second area 108 and emission of the disturbing light 132 into the first area 206) occurs. In various embodiments, for example, when the lighting device 222 is disposed in a cavity, as shown in FIG. 2, an inner surface 228 of the cavity (here, the frame 114) may be formed to be reflective so that efficiency of the lighting device 222 and uniformity of the light 230 may be achieved.

In various embodiments (see, for example, FIG. 2 and FIG. 3), the lighting device 222 may be disposed on more than one edge of the privacy protection device 100 or the brightness difference device 110, for example on two, three or four edges, generally on all edges of the privacy protection device 100, or on only a portion of the edge or edges of the privacy protection device 100.

The lighting device 222 may be connected to an energy source, for example a voltage source 440 (see, for example, FIG. 4). The power source, for example, a mains voltage (possibly transformed) or a battery (e.g., rechargeable), possibly in conjunction with solar cells 660 (see FIG. 6) may be used to power the lighting device 222 in a known manner.

In various embodiments, the privacy protection device 100 may be permanently active, i.e., the first side 102 may be permanently brighter (in the manner described) than the second side 104.

In various embodiments, the privacy protection device 100 may further be connected to a switch (not shown). The switch may be arranged such that an operation of the lighting device 222 may be turned on and off by means of the switch. For example, when it is dark in the first area 106, when it is bright in the second area 108, and/or when it is brighter in the second area 108 than in the first area 106, the lighting device 222 may be turned, and when it is bright in the first area 106, dark in the second area 108, and/or when it is brighter in the first area 106 than in the second area 108, the lighting device 222 may be turned off. As explained in more detail in connection with FIG. 8, the switch may be or operated by sensors. FIG. 3 shows schematic perspective views of two privacy protection devices 100 (100b and 100c, respectively) according to various embodiments. A view from the first area 106 to the first side 102 is shown on the left, and a view from the second area 108 to the second side 104 is shown on the right.

The privacy protection devices 100b, 100c may correspond exactly (in the case of 100b) or substantially (in the case of 100c) to the privacy protection device 100a, for example with regard to materials, dimensioning, function, etc., so that the description in this regard is not repeated.

In the privacy protection device 100b, the brightness difference device 110 is formed as a grid structure, for example as a (e.g. rigid) grid having a bright side 102 and a dark side 104.

In the exemplary privacy protection device 100c, a different design (elliptical elements distributed over the surface to be protected from being seen through) of the brightness difference device 110 is shown.

In various embodiments, the brightness difference device 110 may be mounted, for example, on a transparent carrier material, e.g. glass or plexiglass, may be arranged, for example, as two superimposed textured layers of paint, a light color, e.g. white, for the first side 102 and a dark color, e.g. black, for the second side 104.

In various embodiments, the light emitting device 222 may be formed in a surface of the privacy protection device 100, for example as LEDs distributed in the surface, which may emit directly towards the first area 106, and/or indirectly by having their light emitted at least partially parallel or nearly parallel to the surface of the brightness difference device 110 and reflected and/or scattered and/or re-emitted by the first side 102 of the brightness difference device 110. FIG. 3 illustrates for each of the privacy shields 100b, 100c how the light emitted by the light emitting device 222 (see FIG. 2) directed through the light apertures 226 to the respective first side 102 is scattered and/or reflected and/or re-emitted by the respective first side 102 towards the first area and enters the first area 106 as disturbing light 132, whereas in each case no light (neither the light 230 of the lighting device 222, nor the disturbing light 132 scattered/reflected by the brightness difference device 110) is emitted through the second side 104 into the respective second area 108.

The privacy protection device 100, 100d of FIG. 4 may substantially correspond to the privacy protection devices 100a, 100b and/or 100c, for example with respect to materials, dimensioning, function, etc., so that a repetition of the description in this regard is dispensed with.

In contrast to the embodiments described above, the privacy protection device 100d may include a lighting device 222 formed as a structured surface as the first side 102 of the brightness difference device 110, which emits the disturbing light 132 toward the first area 106. Here, the lighting device 222 may be formed such that no part or at most a negligible part of the disturbing light 132 is emitted towards the second area 108.

In order to prevent radiation into the second area 108, the brightness difference device 110 may be provided with an opaque layer on the second side 104, for example. In various embodiments, the opaque layer may be formed to be reflective in the direction towards the first area 106. Thus, for example, light originally emitted in the direction of the second area 108 may be reflected in such a way that it is additionally emitted in the direction of the first area 106. In the direction towards the second area 108, the opaque layer may be formed to be absorbent, for example black or with another dark color.

In various embodiments, the two-dimensional light source may require an energy source 440 to generate the disturbing light 132. The two-dimensional light source 222 may include, for example, an organic light emitting diode (OLED), or may include, for example, an electroluminescent layer, such as an electroluminescent film or electroluminescent paint (such as Lumilol®).

The two-dimensional light source 222 may be formed on a transparent substrate, for example on a transparent glass or plastic, e.g. plexiglass. In the case of an OLED or an electroluminescent layer, for example, at least one electrode facing the first area 102 may be transparent, so that the disturbing light 132 emitted by the luminescent layer may be emitted into the first area 106 through the transparent electrode. In various embodiments, a second electrode of the OLED or the electroluminescent layer may be opaque, so that penetration of disturbing light 132 by means of the second electrode may be avoided. Alternatively or additionally, an opaque layer independent of the electrode may be disposed on the second side 104 of the brightness difference device 110.

In various embodiments, as described above, the two-dimensional light source 222 may also emit the disturbing light 132 without an energy source, for example in the form of phosphorescent disturbing light 132. A phosphorescence of the phosphorescent two-dimensional light source formed as the first side 102 of the brightness difference device 110 may be excited by means of daylight or ambient light, for example.

The privacy protection device 100, 100e shown in FIG. 5 may essentially correspond to the privacy protection devices 100 (100a to 100d) already described, for example with regard to materials, dimensioning, function, etc., so that a repetition of the description in this regard is omitted.

In contrast to the embodiments described above, the privacy protection device 100, 100e may include a transparent substrate 550 in which the brightness difference device 110 is formed, for example by light guiding regions 560. Non-light guiding regions 558 may be formed in the transparent substrate 550 adjacent to each of the light guiding regions 560. In various embodiments, a refractive index of the transparent substrate 550 may be higher in the light guiding regions 560 than in the non-light guiding regions 558, so that light 230, which may be introduced by a lighting device 222 through light introduction region 556, may be guided in the light guiding region 560 by allowing total internal reflection to occur at interfaces with the non-light guiding regions 558. This may be achieved by means of methods known in principle to the person skilled in the art. On the second side 104 of the brightness difference device 110, i.e. the light-conducting regions 560, the transparent substrate 550 may be coated to be opaque, in such a way that one side of the coating facing the second area 108 is dark, e.g. black or the like, and one side facing the light-conducting region 560 is formed to be reflective, for example. On the one hand, this may prevent light (the light 230 emitted by the lighting device 222 and/or the disturbing light 132) from penetrating into the second area 108, and at the same time the light 230 emitted by the lighting device 222 is not absorbed by the opaque layer, or at most to a negligible extent.

In various embodiments, the first side 102 of the brightness difference device 110, here the side of the light guiding regions 560 of the transparent substrate 550 facing the first area 106, may be formed to be scattering, such that a portion of the light 230 incident on the first side 102 from the inside and guided in the light guiding region 560 is not totally reflected at the first side 102, but exits the first side 102 and is emitted into the first area 106 as disturbing light 132. At the first side 102, the brightness difference device 110, i. e., the side 102 of the light guiding regions 560 facing the first area 106, may be roughened, for example. In various embodiments, a light scattering effect may be increasingly strong as the distance from the light emitting device 222 increases to compensate for a decreasing intensity of light that may be scattered out (due to light already scattered out of the light guiding region 560 closer to the light emitting device 222) and to allow for a relatively uniform emission of disturbing light 132 over the surface of the brightness difference device. In various embodiments, instead of the transparent substrate 550 with the light guiding regions 560, for example, a brightness difference device 110 with a different type of light conduction regions (not shown) may be used, for example a plurality of optical fiber regions, for example, a plurality of optical fibers (e.g., glass fibers) that are coated to be opaque (and possibly reflective toward the optical fiber) on a half facing the second area 108, and light diffusing on a half facing the first area 106. The optical fibers may, for example, be arranged parallel to one another, or, for example, in two planes of mutually parallel, intersecting optical fibers. For example, disturbing light may be scattered from the optical fibers into the first area 106, whereas light emission into the second area 108 is avoided.

In various embodiments, the entire transparent substrate may form the light-conducting substrate 560, for example, in a case where UV light invisible to the viewer is coupled in, which remains invisible to the viewer even when scattered into the second area 108, for example, and the brightness difference device 110 may be disposed in the second area 108 adjacent to the light-conducting substrate 560 and have the first side 102 directed toward the first area 106, which may have a fluorescent or phosphorescent dye that converts the invisible UV light into visible light and emits it as the disturbing light 132 toward the first area 106. The brightness difference device 110 may further include a dark layer, which may be arranged to prevent the disturbing light 132 from entering the second area 108. In various embodiments, it may be sufficient to apply a bandstop filter (also referred to as a notch filter) that prevents the disturbing light 132 from being emitted towards the second area.

The privacy protection device 100, 100f of FIG. 6 may substantially correspond to the privacy protection devices 100a to 100e, for example with respect to materials, dimensioning, function, etc., so that a repetition of the description in this regard is omitted. In addition to the privacy protection device 100b, 100c, 100d, 100e (here, the privacy protection device 100d is shown as an example), the privacy protection device 100, 100f according to various embodiments may further include at least one solar cell 660, which may be used as an energy source 440 to operate the privacy protection device 100, 100f, for example to illuminate or light up the first side brightness difference device 110. To bridge periods of lack of illumination (during which the privacy protection device 100 may be particularly needed), the privacy protection device may further include at least one energy storage device (not shown) in which the energy generated by the at least one solar cell 660 may be stored, and possibly further including an additional energy supply or storage device if the energy generated by the at least one solar cell 660 is insufficient. In various embodiments, the at least one solar cell 660 may be disposed, for example, in an edge region of the privacy protection device 100f, for example on the frame (114, see FIG. 1), for example at one edge (as shown in FIG. 6) or at multiple edges, for example surrounding the surface of the privacy protection device 100f (not shown).

The privacy protection device 100, 100g of FIG. 7 may essentially correspond to the privacy protection devices 100a to 100f, for example with regard to materials, dimensioning, function, etc., so that a repetition of the description in this regard is omitted.

In various embodiments, the brightness difference device 110 and the transparent openings 112 may be flexible. For example, the brightness difference device 110 may include a flexible material, e.g., a flexible fabric, e.g., a fabric of natural or artificial flexible material, or, for example, a flexible textured layer or stack of layers, e. g., of a plastic material, e.g., silicone, PVC, or a similar suitable material.

For a privacy protection device 100, 100g in which a light-conducting brightness difference device 110 is to be used as in the privacy protection device 100e, a flexible transparent light-conducting material, for example a light-conducting film, may be used.

For a privacy protection device 100, 100g, in which the brightness difference device 110 emits the disturbing light 132 directly from its first side 102, as described, for example, in FIG. 4 in connection with the privacy protection device 100d, a flexible OLED or a flexible electroluminescent film may be used, for example.

The flexible privacy protection device 100g may be used as a roller blind, i.e. the brightness difference device 110 may be rolled up and unrolled in directions 772. When rolled up, the brightness difference device 110 may be stowed in a roller blind box 770.

In various embodiments, for example in a case in which an additional light device 222 (see, for example, FIG. 2 or FIG. 5) is used, the light device 222 may be arranged in the roller blind box, for example axially in the roller blind box 770, from where the light 230 may be directed into the brightness difference device 110, or from where the lighting device 222 may illuminate the first side 102 of the unrolled brightness difference device 110. In such a case, or even in the case of an lighting device 222 arranged in another area of the roller blind box 770, the roller blind box 770 may serve as a diaphragm that limits the light 230 emitted by the lighting device 222 such that the light 230 reflected or scattered from the first side 102 is only emitted as disturbing light 132 into the first area 106, and no light or only negligibly little light is emitted into the second area 108.

In various embodiments, the lighting device 222 may be arranged in the flexible privacy protection device 100, 100g at a location other than in or on the roller blind box 770, for example arranged at the lower edge 110u of the brightness difference device 110 and from there radiating the light 230 into the brightness difference device 110 or onto the first side 102 of the brightness difference device 110. In various embodiments, the flexible privacy protection device 100g may also be configured without a light emitting device 222, for example as described in connection with the privacy protection device 100a.

In various embodiments, it may be sufficient if the privacy protection device 100g is not completely flexible, but is only flexible in the rolling direction. In a direction perpendicular to the rolling directions 772, the privacy protection device 100g may be rigid.

In various embodiments, for example in a case of a rigid or non-rollable flexible brightness difference device 110, the brightness difference device 110 may extend in the direction of the roll axis. Individual segments of the brightness difference device extending along the rolling axis may be connected to one another by means of a rollable flexible carrier.

The privacy protection device 100, 100h of FIG. 8 may essentially correspond to the privacy protection devices 100a to 100g, for example with regard to materials, dimensioning, function, etc., so that a repetition of the description in this regard is omitted.

The privacy protection device 100h may include at least one light sensor 882 in addition to one of the privacy protection devices 100 described above, for example in addition to one of the privacy protection devices 100 including an energy driven lighting device 222, for example in addition to the privacy protection device 100b, 100d, 100e or 100f. The light sensor 882 may be configured to receive light 880, such as ambient light 880, which enables, for example, a determination of the brightness in the first area 106.

In various embodiments, the privacy protection device 100h may be operable, i.e., effective, for example, the first side 102 of the brightness difference device 110 may illuminate or be illuminated when the light 230 received by the light sensor 882 from the first area 106 falls below a predetermined intensity.

In various embodiments, the light sensor may be arranged to enable determination of a brightness in the second area 108 (not shown).

In various embodiments, the privacy protection device 100h may be operable, i. e., effective, for example, the first side 102 of the brightness difference device 110 may illuminate or be illuminated when the light 230 received by the light sensor 882 from the second area 108 exceeds a predetermined intensity.

In various embodiments, the privacy protection device 100f may include a plurality of light sensors 882, such as a first light sensor 882 that may be configured to receive light 880, such as ambient light 880, which enables, for example, a determination of brightness in the first area 106, and further include a second light sensor that enables a determination of a brightness in the second area 108.

In various embodiments, the privacy protection device 100h may be operated, i. e., be effective, for example, the first side 102 of the brightness difference device 110 may illuminate or be illuminated when a ratio of light received from the second area 108 and the light received from the first area exceeds a predetermined ratio, for example, when the light received from the second area 108 has a higher intensity than the (ambient) light received from the first area 106.

In various embodiments, the embodiments described above may be combined in any number of ways that are not technically mutually exclusive. In various embodiments, the privacy protection device 100 may have both the solar cell 660 and the light sensor 880.

In various embodiments, a privacy protection device may be designed as a roller blind and still have a frame 114. Here, for example, the brightness difference device 110 designed as a roller blind may be guided in the frame 114.

In various embodiments, the privacy protection device 100 may include a brightness difference device 110 having a phosphorescent first side 102, and may additionally include a lighting device 222 that may illuminate the phosphorescent first side 102.

In particular, the embodiments in which the first side 102 is designed to be self-luminous (e.g. by means of OLED or the like), different colors may be combined with each other, which may be designed graphically, for example, as an image. In this way, it may be possible to match the privacy protection device 100 to its surroundings.

In particular, the embodiments in which the first side 102 is passively illuminated, the light source 222 may include a plurality of light sources 222 of different colors and/or filters, each of which provides only a portion of the light generated by the light source 222 as the disturbing light. This may serve the purpose of rendering useless, or at least complicating the use of such a device, devices that may be set up to provide a view from the first area 106 into the second area 108 by masking out the disturbing light wavelength.

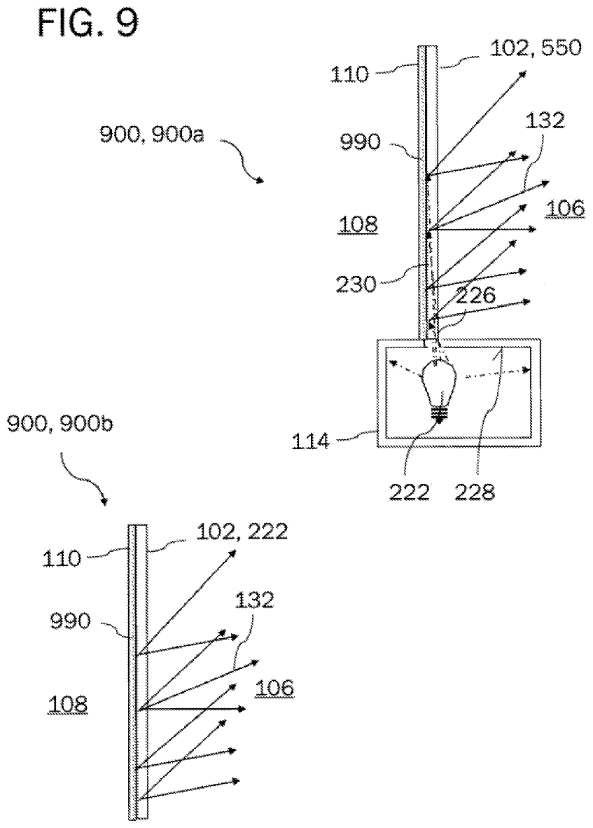

According to various embodiments, the privacy protection device 100 may be designed to be self-supporting or, for example, to be mounted or suspended on a support (e.g., a window). FIG. 9 shows a schematic illustration of two privacy protection devices 900 (900a top, 900b bottom) according to various embodiments.

The privacy protection devices 900 may be arranged to fulfill the task described above in connection with the privacy protection device 100. In particular, the privacy protection device 900 may be arranged to at least temporarily protect the second area from a view from the first area and to allow a view from the second area into the first area.

The privacy protection device 900 may include a brightness difference device 110 that includes a first side 102, which is directed towards the first area 106 (e. g., to the exterior), and a second side 990, which is opposite the first side 102 and directed towards the second area 108 (e. g., an interior), the first side 102 of the brightness difference device 110 may be at least temporarily brighter than the second side 990 of the brightness difference device 110, in that the first side 102, in contrast to the second side 990, is self-illuminating or illuminated in the direction towards the first area 106 (i.e., disturbing light 132 is emitted in the direction towards the first area 106) and the second side 990 is provided with a filter or is formed from a filter that in particular blocks light of a wavelength that forms the disturbing light 132.

Accordingly, the privacy protection device 100 may appear darker on the second side 990 (i.e., looking from the second area 108 into the first area 106) than vice versa, however, the entire area provided with the privacy protection device 900 may be transparent or substantially transparent.

In various embodiments, the wavelength of the disturbing light 132 may be selected (depending on the environment, for example) such that filtering it out does not affect or only insignificantly affects the visual impression for the viewer in the second area 108 looking into the first area 106. In the privacy protection device 900a, the disturbing light 132 may be guided by a light source 222 by means of light conduction in a transparent substrate 550 and scattered/radiated towards the first area 106.

Even though the light source 222 is shown as a stylized light bulb, light sources 222 with a narrow band emission characteristic, for example LEDs or gas emission lamps, are more suitable for the privacy shield 900a.

In the privacy protection device 900b, the disturbing light 132 may be generated by a transparent layer 102 (e.g., a transparent OLED) formed as a light source 222 and may be emitted toward the first area 106.

For example, the filter may be formed as a so-called notch filter (also referred to as a band block filter), which is arranged to block only a narrow-band region around the wavelength of the disturbing light 132. For example, an LED may be used that emits yellow light as the disturbing light 132, e.g., light in a wavelength range of 570 nm to 590 nm, and the second side 990 may have a notch filter centered at 580 nm and having an FWHM width of, e.g., 25 nm.

Alternatively, the filter may be formed as an edge filter that only transmits light with a wavelength above a cut-off wavelength or only transmits light below a cut-off wavelength, wherein the cut-off wavelength or the wavelength of the disturbing light 132 is then selected such that the disturbing light 132 is in the blocked range. For example, very short wavelength visible blue light may be used as the disturbing light 132, and the cut-off wavelength may be selected to transmit light from the longer wavelength blue range to the red range (and possibly beyond). Or conversely, very long wavelength visible red light may be used as the disturbing light 132, and the cutoff wavelength may be selected to transmit light from the short wavelength red region to the short wavelength blue region (and possibly beyond). An amount of light transmitted from the first area 106 into the second area 108 (i.e., how transparent the privacy protection device 900 appears when looking from the second area 108 into the first area 106) may be higher when a band block filter is used. However, a band block filter may be more expensive than an edge filter, so it may be attractive to accept reduced transparency in order to provide a less expensive embodiment.

With respect to other aspects, the privacy protection device 900 may be formed similarly or identically to the privacy protection device 100. For example, it may include a frame 114, a switch, a power source 440, a solar cell 660, and/or a brightness sensor 880, and/or may be configured as a roller blind. It may be designed to be self-supporting, or such that it is mounted on a support (e.g., a window), etc.

Some examples of embodiments are summarized below.

Exemplary embodiment 1 is a privacy protection device that separates a first area and an opposite second area and is arranged to at least temporarily protect the second area from a view from the first area and to allow a view from the second area into the first area. The privacy protection device has a brightness difference device that has a first side that faces the first area and a second side that is opposite the first side and faces the second area, the first side of the brightness difference device being at least temporarily brighter than the second side of the brightness difference device, in that the first side, in contrast to the second side, is self-luminous in the direction of the first area, and/or the first side has a higher reflectivity than the second side and the first side is illuminated by a luminous device integrated in the privacy protection device.

Exemplary embodiment 2 is a privacy protection device separating a first area and an opposite second area, the privacy protection device including a two-dimensional brightness difference device having a first side facing the first area and a second side opposite the first side and facing the second area, the brightness difference device being brighter on the first side than on the second side, and a plurality of substantially transparent openings connecting the first area to the second area, wherein the privacy protection device is designed such that an observer is able to perceive objects located behind the privacy protection device in the first area from the second area through the plurality of transparent openings, and perceiving objects located behind the privacy protection device in the second area from the first area is made more difficult or impossible, because the light reflected and/or emitted from the first side of the brightness difference device dominates a light emitted from the object located in the second area into the first area.

Exemplary embodiment 3 is a privacy protection device according to exemplary embodiment 1 or 2, which further includes a lighting device that is arranged such that its light is reflected and/or emitted from the first side of the brightness difference device in the direction of the first area.

Exemplary embodiment 4 is a privacy protection device according to one of the previous exemplary embodiments, wherein the brightness difference device is designed to be more diffusing and/or reflective on the first side than on the second side.

Exemplary embodiment 5 is a privacy protection device according to one of the previous exemplary embodiments, wherein the brightness difference device is configured self-luminating in the direction of the first area, whereas radiation in the direction of the second area is prevented.

Exemplary embodiment 6 is a privacy protection device according to one of the previous exemplary embodiments, wherein the brightness difference device is designed in the form of a strip.

Exemplary embodiment 7 is a privacy protection device according to one of exemplary embodiments 3 to 6, wherein the lighting device is arranged on at least one edge of the privacy protection device.

Exemplary embodiment 8 is a privacy protection device according to one of the previous exemplary embodiments, which further includes a transparent substrate on and/or in which the brightness difference device is formed.

Exemplary embodiment 9 is a privacy protection device according to exemplary embodiment 8, wherein the brightness difference device has light guiding regions formed in the transparent substrate, wherein light is guided in the light guiding regions, wherein light is irradiated into the light guiding regions at a light introduction region by means of the lighting device, and wherein the light guiding regions have a scattering surface on the first side so that a part of the light guided in the light guiding regions is irradiated from the first side toward the first area.

Exemplary embodiment 10 is a privacy protection device according to exemplary embodiment 9, wherein a scattering effect of the scattering surface increases in a direction pointing away from the irradiation area.

Exemplary embodiment 11 is a privacy protection device according to one of exemplary embodiments 3 to 10, wherein the lighting device includes at least one LED.

Exemplary embodiment 12 is a privacy protection device according to exemplary embodiment 11, wherein the LED is an OLED, and wherein the at least one OLED is formed in the surface of the brightness difference device such that it radiates in the direction of the first area.

Exemplary embodiment 13 is a privacy protection device according to one of the previous exemplary embodiments, which further includes a frame. Embodiment example 14 is a privacy protection device according to one of the previous embodiments, which is designed as a roller blind.

Exemplary embodiment 15 is a privacy protection device according to one of the previous exemplary embodiments, wherein the dimensions of the brightness difference device and the dimensions of the openings are dimensioned in such a way that an uninterrupted field of view is obtained for an observer looking through the privacy protection device when focusing on an object located behind the privacy protection device.

Exemplary embodiment 16 is a privacy protection device according to one of the previous exemplary embodiments, wherein the brightness difference device has a maximum width of 3 mm everywhere.

Exemplary embodiment 17 is a privacy protection device according to exemplary embodiments 15 or 16, wherein the uninterrupted field of view results at least when the viewer is at a distance greater than about 20 cm from the privacy protection device and is looking through the privacy protection device from an angle greater than about 30 degrees.

Exemplary embodiment 18 is a privacy protection device according to one of the previous exemplary embodiments, which further includes at least one solar cell.

Exemplary embodiment 19 is a privacy protection device according to exemplary embodiments 18, wherein the energy generated by the at least one solar cell is used to operate the privacy protection device.

Exemplary embodiment 20 is a privacy protection device according to one of the previous exemplary embodiments, which further includes at least one brightness sensor, wherein the brightness sensor is arranged to control the privacy protection device such that the first side lights up and/or is illuminated when an ambient brightness determined by the brightness sensor falls below a predetermined limit value.

Exemplary embodiment 21 is a privacy protection device that separates a first area and an opposite second area and is set up to protect the second area at least temporarily from a view from the first area and to allow a view from the second area into the first area. The privacy protection device includes a brightness difference device having a first side facing the first area and a second side opposite the first side and facing the second area, wherein the first side of the brightness difference device is at least temporarily brighter than the second side of the brightness difference device, in that: the first side emits light of a predetermined wavelength, and the second side includes a filter that blocks the light of the predetermined wavelength and transmits light of other wavelengths.

Exemplary embodiment 22 is a privacy protection device according to exemplary embodiment 21, wherein the filter is a notch filter that blocks the light emitted from the first side but allows light with shorter wavelengths and light with longer wavelengths to pass.

Exemplary embodiment 23 is a privacy protection device according to exemplary embodiment 21, wherein the filter is an edge filter that blocks the light emitted from the first side but transmits light with longer wavelengths.

Exemplary embodiment 24 is a privacy protection device according to exemplary embodiment 21, wherein the filter is an edge filter that blocks the light emitted from the first side but transmits light with shorter wavelengths.

1. A privacy protection device that separates a first area and an opposite second area and is arranged to at least temporarily protect the second area from a view from the first area and to allow a view from the second area into the first area, the privacy protection device comprising:
a brightness difference device, comprising:
a first side facing the first area;
a second side opposite the first side, and facing the second area;
wherein the first side of the brightness difference device is at least temporarily brighter than the second side of the brightness difference device by:
the first side, in contrast to the second side, being self-luminous only in the direction of the first area, and/or
the first side; having a higher reflectivity than the second side and the first side being illuminated by a lighting device integrated in the privacy protection device in such a way that light from the lighting device is reflected and/or emitted only in the direction of the first area.

2. A privacy protection device according to claim 1, further comprising:
the lighting device.

3. A privacy protection device according to claim 2,
wherein the lighting device is arranged on at least one edge of the privacy protection device.

4. A privacy protection device according to claim 1, further comprising:
a transparent substrate on and/or in which the brightness difference device is formed.

5. A privacy protection device according to claim 4,
wherein the brightness difference device comprises light guiding regions formed in the transparent substrate, wherein light is guided in the light guiding regions and is irradiated into the light guiding regions at a light introduction region by means of the light emitting device, and
wherein the light guiding regions have a scattering surface on the first side, so that a part of the light guided in the light guiding regions is radiated from the first side towards the first area.

6. A privacy protection device according to claim 2, wherein the lighting device comprises at least one LED or at least one OLED.

7. A privacy protection device according to claim 1, wherein the first side comprises a layer excitable to fluorescence and/or phosphorescence.

8. A privacy protection device according to claim 1, further comprising:
at least one brightness sensor,
wherein the brightness sensor is arranged to control the privacy protection device such that the first side lights up and/or is illuminated when an ambient brightness determined by the brightness sensor falls below a predetermined limit value.

9. A privacy protection device that separates a first area and an opposite second area and is arranged to at least temporarily protect the second area from a view from the first area and to allow a view from the second area into the first area, comprising the privacy protection device:
a brightness difference device, comprising:
a first side facing the first area;
a second side opposite the first side and facing the second area;
wherein the first side of the brightness difference device is at least temporarily brighter than the second side of the brightness difference device by:
the first side emitting disturbing light of a predetermined wavelength, and
the second side having a filter that always blocks the disturbing light of the predetermined wavelength and transmits light of other wavelengths.

10. A privacy protection device according to claim 9,
wherein the stray light is generated by a light source with narrowband emission characteristics.

11. The privacy protection device according to claim 7,
wherein the privacy protection device further comprises a light emitting device arranged to emit light exciting the fluorescence and/or phosphorescence.

12. The privacy protection device according to claim 11,
wherein the light is UV light
